(19) United States
(12) Patent Application Publication
(10) Pub. No.: US 2011/0029580 A1
(43) Pub. Date: Feb. 3, 2011

(54) METHODS AND APPARATUS FOR METADATA MANAGEMENT IN A STORAGE SYSTEM

(75) Inventors: Vladimir Popovski, Irvine, CA (US); Alexander Lyakas, Haifa (IL)

Correspondence Address: Duft Bornsen & Fishman LLP, 1526 Spruce Street, Suite 302, Boulder County, CO, 80302, US

(73) Assignee: LSI CORPORATION, Milpitas, CA (US)

(21) Appl. No.: 12/510,791

(22) Filed: Jul. 28, 2009

(51) Int. Cl. G06F 12/00; G06F 7/00

(52) U.S. Cl. 707/812; 707/E17.044; 711/E12.001

(57) ABSTRACT

Methods and systems for metadata management in a storage system are disclosed. First level metadata is associated with a plurality of storage devices in a storage system. Entries in the first level metadata identify storage related attributes of corresponding portions on the plurality of storage devices. Entries in a second level metadata are associated with a corresponding plurality of entries in the first level metadata, where the second level metadata identifies metadata related attributes of the corresponding first level metadata entries. Responsive to receiving a request for a storage related attribute in the first level metadata table, the storage related attribute is derived from the second level metadata table, which reduces the first level metadata processing requirements and increases the performance of the storage system.

### BACKGROUND

1. Field of the Invention

The invention relates generally to metadata processing for a storage system, and more specifically, relates to improving performance in a storage system using metadata management.

2. Related Patents

This patent is related to commonly owned United States patent application having LSI Docket Number 08-1353 and entitled METHODS AND APPARATUS FOR REDUCING INPUT/OUTPUT OPERATIONS IN A RAID STORAGE SYSTEM which is hereby incorporated by reference.

3. Discussion of Related Art

Typically storage systems include a storage controller coupled with one or more storage devices, such as hard disk drives. The storage controller is generally responsible for receiving and processing Input/Output (I/O) requests from one or more attached host systems requesting the reading or writing of particular identified information.

For example, in the context of a RAID level 5 storage system, read and write I/O operations may be generated to retrieve and store information associated with the generation and checking of the XOR parity information managed by the storage controller. In like manner, additional I/O requests may be generated within a storage controller when rebuilding or regenerating a RAID volume in response to failure and replacement of one or more storage devices. Still further, other internally generated I/O operations may relate to reorganizing information stored in a logical volume of a storage subsystem. Logical volumes comprise logical block addresses mapped to physical storage on portions of one or more storage devices. Those of ordinary skill in the art will readily recognize a wide variety of operations that may be performed by a storage controller of the storage system that may generate I/O requests internal to the storage controller to be processed substantially concurrently with other internally generated I/O requests and substantially concurrently with ongoing I/O requests received from attached host systems.

In some cases, the storage controller may utilize metadata for improved performance of the storage system. For example, metadata associated with storage devices can identify underlying characteristics or attributes of the storage devices to reduce calculation requirements on the storage controller, reduce I/O operations performed by the storage controller, or enable other performance enhancing features. In some cases, however, such metadata can become large and unmanageable due to the amount of data generated and the requirements for processing such metadata, thus reducing the performance of the storage system.

Thus it is an ongoing challenge to reduce the management requirements of metadata associated with storage devices in a storage system to improve performance of the storage system.

### SUMMARY

The present invention solves the above and other problems, thereby advancing the state of the useful arts, by providing methods and systems for managing second level metadata to summarize features and attributes of first level metadata in a storage system.

In one aspect hereof, a method is provided for managing metadata in a storage system having a plurality of storage devices. According to the method, entries in a first level metadata table are associated with a corresponding portion of the storage devices, where the first level metadata table identifies storage related attributes of the portions of the storage devices. A second level metadata table is associated with the first level metadata table, where entries in the second level metadata table identify metadata related attributes of entries in the first level metadata table. Responsive to receiving a request for a storage related attribute in the first level metadata table, the second level metadata table is processed to identify a metadata related attribute corresponding to the first metadata table. The storage related attribute is derived based on the metadata related attribute. A response to the request for the storage related attribute is made using the derive storage related attribute.

Another aspect hereof provides storage system. The storage system comprises a plurality of storage devices, a first level metadata table, a second level metadata table, and a storage controller coupled to the plurality of storage devices. The first level metadata table includes entries associated with corresponding portions of storage devices, where each entry identifies a storage related attribute of a corresponding portion of the storage devices. The second level metadata table includes entries associated with a corresponding plurality of entries of the first level metadata table, where each entry in the second level metadata table identifies a metadata related attribute of the corresponding entries in the first metadata table. The storage controller is operable to receive a request for a storage related attribute in an entry of the first level metadata table. The storage controller, responsive to the request, is further operable to process the second level metadata table to identify a metadata related attribute corresponding to the entry in the first level metadata table. The storage controller is further operable to derive the storage related attribute of the entry in the first level metadata table based on the identified metadata related attribute, and operable to respond to the request for the storage related attribute using the derived storage related attribute.

### BRIEF DESCRIPTION OF THE DRAWINGS

FIG. 1 is a block diagram of an exemplary storage system in accordance with features and aspects herein for managing metadata.

FIG. 2 is a block diagram of an exemplary storage controller in accordance with features and aspects herein.

FIG. 3 is a flowchart describing an exemplary method in accordance with features and aspects herein for managing metadata in a storage system.

FIG. 4 depicts exemplary storage devices and a first level metadata table in accordance with features and aspects herein.

FIG. 5 depicts an exemplary first level metadata table and an exemplary second level metadata table in accordance with features and aspects herein.

FIG. 6 depicts an exemplary first level metadata table and an exemplary second level metadata table in accordance with features and aspects herein.

FIG. 7 is a flowchart describing an exemplary method in accordance with features and aspects herein for storing metadata in a storage system.

FIG. 8 is a flowchart describing an exemplary method in accordance with features and aspects herein for updating metadata in a storage system.

### DETAILED DESCRIPTION OF THE DRAWINGS

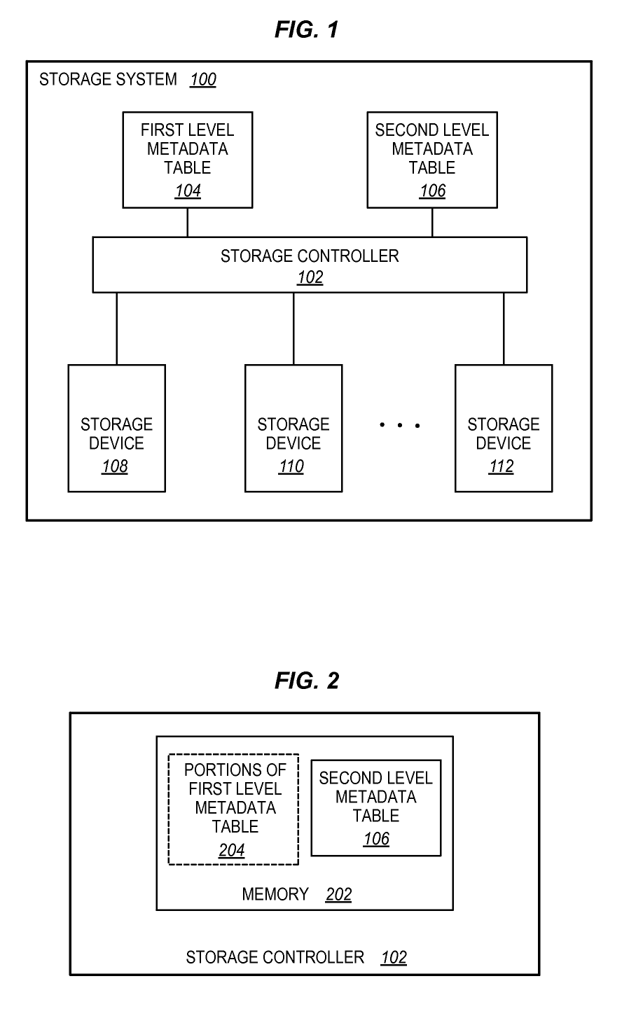

FIG. 1 is a block diagram of an exemplary storage system 100 in accordance with features and aspects herein for managing metadata to improve the performance of storage system 100. Storage system 100 includes a plurality of storage devices 108-112, a storage controller 102, a first level metadata table 104, and a second level metadata table 106. Storage devices 108-112 may include a variety of types of devices operable for persistently storing data, such as hard disk drives, flash disk drives, battery backed random access memory drives (also known as “ramdisks”), or other types of devices operable for persistently storing data. Storage devices 108-112 may be coupled with storage controller 102 using any number of interfaces, such as parallel or serial attached SCSI, parallel or serial ATA, IDE, Fibre Channel, or other interfaces operable for transmitting and receiving data between storage controller 102 and storage devices 108-112. One skilled in the art will recognize that storage controller 102 may generate a number of I/O requests for data on storage device 108-112, including write requests, read requests, or other types of requests operable to write data to, or read data from, storage devices 108-112.

First level metadata table 104 of FIG. 1 includes entries associated with portions of storage devices 108-112, where each entry in metadata table 104 identifies a storage related attribute of a corresponding portion of storage devices 108-112. For example, storage device 108 may comprise a number of portions (e.g., blocks or clusters) for which first level metadata table 104 may include a table entry identifying a storage related attribute of the corresponding portion. First level metadata table 104, may, for example, indicate a storage related attribute of either “initialized” or “non-initialized” for corresponding portions of storage device 108. When first level metadata table 104 indicates that a corresponding portion on storage device 108 is initialized, the corresponding portion may include valid data for a storage volume (not shown) which includes storage device 108. Conversely, when first level metadata table 104 indicates that a corresponding portion on storage device 108 is non-initialized, the corresponding portion may not include valid data for a storage volume (not shown) which includes storage device 108. Thus, in this example, first level metadata table 104 includes initialized and non-initialized information for portions of storage device 108. One skilled in the art will recognize that a number of storage related attributes may be represented within first level metadata table 104 corresponding to a number of portions on storage devices 108-112. Another exemplary application of metadata table 104 may include entries indicating portions on storage devices 108-112 which include identical data. Other examples may include entries which include other storage related attributes of portions for storage devices 108-112, such as snapshot or other backup data, such as journal entries indicating changes to various portions on storage devices 108-112 occurring after a backup or snapshot of data contained on storage devices 108-112.

Second level metadata table 106 of FIG. 1 includes entries associated with a corresponding plurality of entries in first level metadata table 104, where entries in second level metadata table 106 identify metadata related attributes of the entries in first level metadata table 104. For example, entries in second level metadata table 106 may indicate that a plurality of entries in first level metadata table 104 are all used, partially used, or completely unused. Other metadata related attributes may include indicating that a plurality of entries in first level metadata table 104 are valid or invalid, initialized or non-initialized, or include a location where the plurality of entries are stored. One skilled in the art will recognize that second level metadata table 106 may be stored in a memory of storage controller 102, within a host system coupled with storage system 100 (not shown) and within a driver or module of the host system, within a Host Bus Adapter (not shown), or within a separate system or appliance couple with storage system 100 (not shown).

Storage system 100 of FIG. 1 also includes the aforementioned storage controller 102. Storage controller 102 is coupled with storage devices 108-112, first level metadata table 104, and second metadata table 106. Storage controller 102 includes any system, device, or circuitry operable to receive a request for a storage related attribute in an entry of first level metadata table 104. Such a request may include, for example, a write request to, or a read request from, an entry in the first level metadata table 104. Storage controller 102 is additionally operable, responsive to the request, to process second level metadata table 106 to identify the metadata related attribute corresponding to the entry in first level metadata table 104. For example, an entry in second level metadata table 106 may indicate a plurality of entries in first level metadata table 104 are “completely unused”. Thus, storage controller 102 would be operable to identify that all of the plurality of entries in first level metadata table 104 are unused without directly accessing the plurality of entries in first level metadata table 104.

Storage controller 102 is further operable to derive the storage related attribute of the entry in the first level metadata table based on the identified metadata related attribute in the second level metadata table. For example, if entries 1-100 of first level metadata table 104 included a storage related attribute indicating that a corresponding plurality of portions on storage devices 108-112 were “non-used”, then an entry in second level metadata table 106 may indicate that entries 1-100 in first level metadata table 104 have a metadata related attribute of “completely unused”. If, for example, storage controller 102 received a request for one or more of the 1-100 entries in first level metadata table 104, then instead of directly accessing first level metadata table to request information for the one or more entries, storage controller 102 may instead access one entry in second level metadata table 106 and derive the storage related attributes of first level metadata table 104. Using this example, storage controller 102 may respond to the original request for entries 1-100 in first level metadata table 104 using the derived storage related attribute. By using second level metadata table 106, the storage controller may realize an increase in performance using metadata table 106 to derive storage related attributes of first level metadata table 104 instead of accessing and processing the first level metadata table 104 directly. Additionally, using second level metadata table 106 reduces memory and/or cache storage requirements for first level metadata 104.

During operation, first level metadata table 104 is updated to reflect the current storage related attributes associated with the corresponding plurality of portions on storage devices 108-112. For example, if a portion on storage device 108 is written with data, an entry in metadata table 104 may be updated to indicate a change from “unused” to “used” for specific entries related to the written portion of storage device 108. When metadata table 104 changes, updates to metadata table 106 may occur to ensure that metadata related attribute of the corresponding entry in second level metadata table 106 reflect the current status of storage related attributes in first level metadata table 104. In the example of writing a portion on storage device 108 and updating first level metadata table 104 to reflect this change, second level metadata table 106 may be changed to reflect that not all of the plurality of entries in first level metadata table 104 are “completely unused” (i.e., now “partly used” or “completely used”). One skilled in the art will recognize that the order of updating first level metadata 104 and second level metadata 106 may vary depending on the type of updating occurring or other design choices utilized when implementing storage system 100 of FIG. 1.

Another example of increasing the performance for storage system 100 in accordance with features and aspects disclosed herein is further illustrated in FIG. 2. FIG. 2 is a block diagram of exemplary storage controller 102 including a memory 202 in accordance with features and aspects herein. Memory 202 of storage controller 102 may be non-volatile memory, such as flash memory or non-volatile random access memory. FIG. 2 illustrates optional aspects of storing second level metadata table 106 in memory 202 of storage controller 102, and additionally storing portions of a first level metadata table 104 in memory 202.

In some cases, first level metadata table 104 of FIG. 1 may be quite large in size. In this case, first level metadata table 104 may be stored directly on one or more storage devices 108-112, while some portions of first level metadata table 104 may be cached in memory 202 of storage controller 102.

Storage controller 102 may additionally be operable to utilize a metadata related attribute in second level metadata table 106 to indicate specifically which storage devices 108-112 contain corresponding portions of first level metadata table 104. For example, second level metadata table 106 may include a metadata related attribute indicating that storage device 108 stores first level metadata table 104. Additionally, the metadata related attribute may indicate which portions of first level metadata table 204 are cached in memory 202 of controller 102.

To further detail by way of example of increasing the performance for storage system 100, storage controller 102 may receive a request for a storage related attribute in an entry of first level metadata table 104 stored directly on storage devices 108-112. In order to directly access the storage related attribute from the entry, storage controller 102 may issue a number of I/O requests for one or more storage devices 108-112 which contain portions of first level metadata table 104 including the requested entry. In this example, a delay may occur when storage devices 108-112 provide access to first level metadata table 104 including the entry, such as when storage devices 108-112 are relatively slow physical hard disk drives. Storage controller 102 may process second level metadata table 106 stored in memory 202 to derive the requested storage related attribute, and respond to the original request using the derived storage related attribute. This type of metadata processing using second level metadata table 106 may increase the performance of storage system 100 of FIG. 1 by reducing or eliminating processing delays associated with first level metadata 104 stored directly on one or more storage devices 108-112, which may be slower to access than memory 202.

Although the previous features and aspects have been described in terms of specific blocks illustrated in FIGS. 1-2, one skilled in the art will recognize that the various elements previously described may be implemented as electronic circuits, programmable logic devices, a custom ASIC (application specific integrated circuit), computer instructions executing on a processing system, and other combinations of hardware and software implementations. Furthermore, the exemplary modular decomposition of FIGS. 1-2 may be implemented as more, less, or different elements as a matter of design choice.

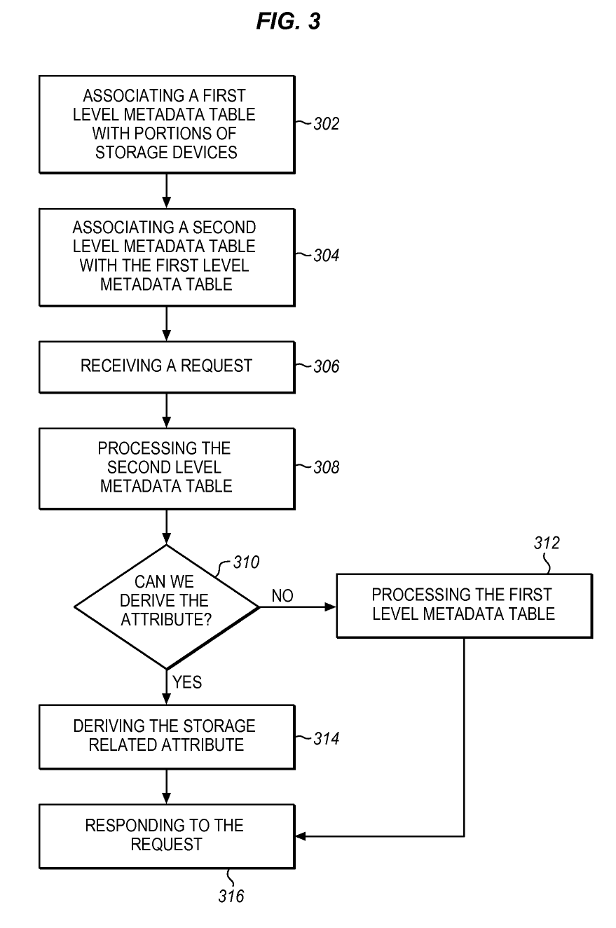

FIG. 3 is a flowchart describing an exemplary method operable on a storage controller, such as controller 102, in accordance with features and aspects herein for managing metadata in a storage system. The method illustrated in FIG. 3 may include other additional and equivalent steps not shown. One skilled in the art will recognize that such additional or equivalent steps may be omitted for brevity and clarity when describing the features and aspects of the method. Step 302 comprises associating a first level metadata table with portions of storage devices.

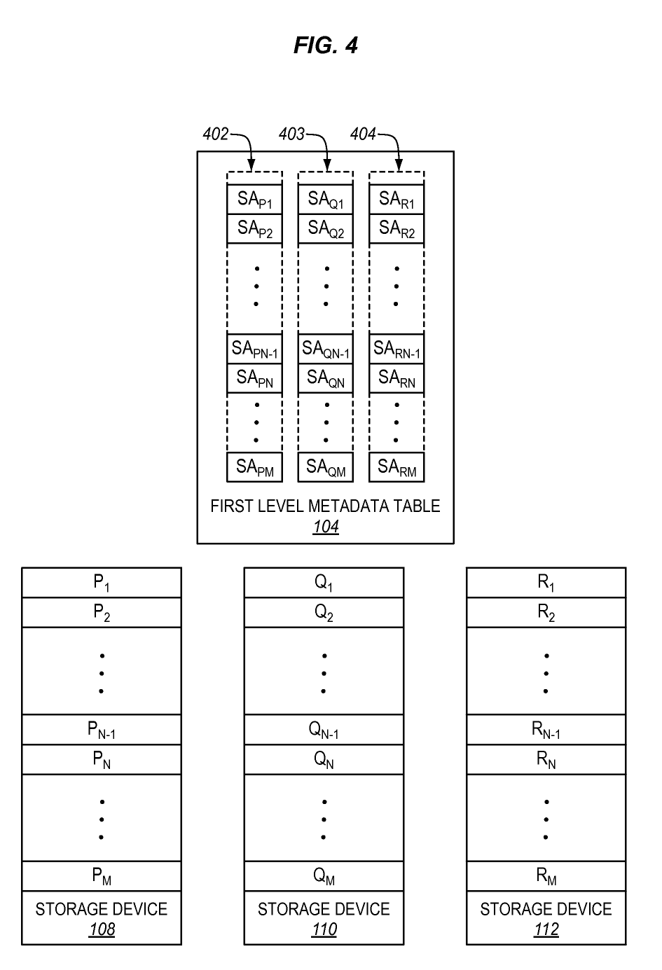

FIG. 4 depicts exemplary storage devices 108 and first level metadata table 104 depicting an exemplary association as performed in step 302 in accordance with features and aspects herein. First level metadata table 104 includes columns 402-404 of storage related attributes of corresponding portions on storage devices 108-112. For example, column 402 includes a first entry SA_{P1}, which corresponds to portion P₁ on storage device 108. Thus, storage related attribute SA_{P1} represents the storage attribute for portion P₁ on storage device 108. Similarly, SA_{P2} of column 402 provides storage attributes for portion P₂ on storage device 108. Additionally, first level metadata table 104 of FIG. 4 illustrates other storage related attributes SA_{Q1}-SA_{QM} of column 403 corresponding to portions Q₁-Q_{M} on storage device 110, and storage related attributes SA_{R1}-SA_{RM} of column 404 corresponding to portions R₁-R_{M} of storage device 112. The types of storage related attributes associated with first level metadata table 104 of FIG. 4 may be similar to those disclosed for first level metadata table 104 of FIGS. 1-2.

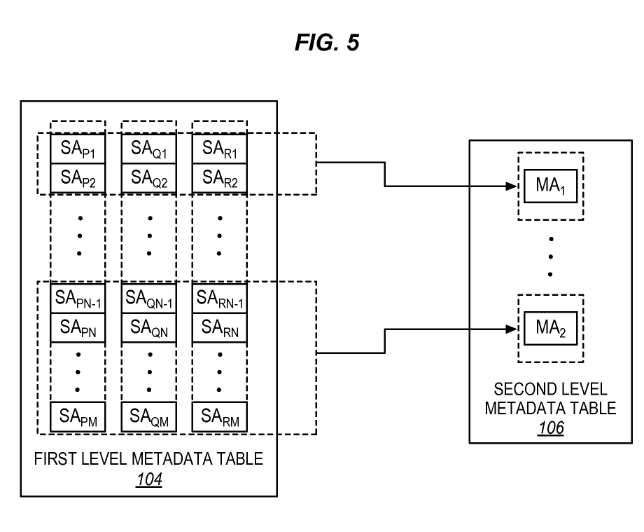

Referring again to FIG. 3, step 304 comprises associating a second level metadata table with the first level metadata table. FIG. 5 depicts an exemplary first level metadata table 104 and an exemplary second level metadata table 106 in accordance with features and aspects herein. In FIG. 5, one example of how entries in second level metadata table 106 may be associated with a plurality of entries in first level metadata table 104 is shown. One skilled in the art will recognize that any number of groupings and associations may be made. In FIG. 5, second level metadata table includes entries indicating metadata related attributes MA₁-MA₂. Metadata related attribute MA₁ corresponds to a plurality of storage attributes SA_{P1}-SA_{P2}, SA_{Q1}-SA_{Q2}, and SA_{R1}-SA_{R2} included within first level metadata table 104. Metadata related attribute MA₂ corresponds to a plurality of storage attributes SA_{PN-1}-SA_{PM}, SA_{QN-1}-SA_{QM}, and SA_{RN-1}-SA_{RM}.

Referring again to FIG. 3, step 306 comprises receiving a request for a storage related attribute in a first level metadata table. For example, a request may be received for storage attributes SA_{P1}-SA_{P2}, SA_{Q1}-SA_{Q2}, and SA_{R1}-SA_{R2} illustrated in FIG. 5. The request may include, for example, accessing one or more storage attributes SA_{P1}-SA_{P2}, SA_{Q1}-SA_{Q2}, and SA_{R1}-SA_{R2} of first level metadata table 104 to determine attributes corresponding with one or more of portions P₁-P₂, Q₁-Q₂, and R₁-R₂ of storage devices 108-112 as illustrated in FIG. 4.

Step 308 comprises processing the second level metadata table to identify the metadata related attribute corresponding to the entry in the first level metadata table. For example, if storage attributes SA_{P1}-SA_{P2}, SA_{Q1}-SA_{Q2}, and SA_{R1}-SA_{R2} illustrated in FIG. 5 were all of the same type of storage attribute, such as all “initialized” (i.e., portions P₁-P₂, Q₁-Q₂, and R₁-R₂ of storage devices 108-112 include written data, or in other words, may not be available for writing new data), then metadata related attributes MA₁ may indicate such using a “completely used” metadata related attribute and identified as such. The metadata related attributes may be identified as used, completely used, partially used, valid, invalid, initialized and non-initialized, or a location of a corresponding plurality of entries (i.e., controller memory, a plurality of storage devices, a specific identified storage device, within a host, another system, a Host Bus Adapter, or within a separate storage appliance).

Step 310 comprises determining if a derivation can be made of the requested storage related attribute from the second level metadata table. For example, in some cases, the metadata related attributes in the second level metadata table may not clearly define the status of the storage related attributes in the first level metadata table. In those cases, the second level metadata table may indicate something similar to “partially used” instead of “all used” or “all unused”. In these cases, it may not be possible to derive a specific storage related attribute from the second level metadata table. If, for example, an entry in the second level metadata table were associated with a hundred entries in the first level metadata table, it is possible that some or most of the first level metadata table entries would not be identical. Thus in this case, the second level metadata table entry may indicate a metadata related attribute of “partially used” for the associated first level metadata table entries. If a request for an storage related attribute is made similar to the request described in step 306, and if the metadata related attribute associated with the requested entry does not specifically define the status of the requested entry, then a derivation of the status may not be possible. In such cases, the first level metadata table may be processed directly as illustrated in step 312 of FIG. 3

Step 314 of FIG. 3 comprises deriving the storage related attribute of the entry in the first level metadata table based on the identified metadata related attribute. For example, if MA₁ indicates that SA_{P1}-SA_{P2}, SA_{Q1}-SA_{Q2}, and SA_{R1}-SA_{R2} are “completely used”, the storage related attribute of “initialized” may be derived for any request for SA_{P1}-SA_{P2}, SA_{Q1}-SA_{Q2}, and SA_{R1}-SA_{R2}.

Step 316 comprises responding to the request for the storage related attribute using the derived storage related attribute of step 314 or the directly accessed storage related attribute as processed by step 312. In the example provided above, a request was received for storage related attributes SA_{P1}-SA_{P2}, SA_{Q1}-SA_{Q2}, and SA_{R1}-SA_{R2} illustrated in first level metadata table 104 of FIG. 5. Instead of accessing SA_{P1}-SA_{P2}, SA_{Q1}-SA_{Q2}, and SA_{R1}-SA_{R2} in first level metadata table 104 directly, metadata related attribute MA₁ is identified and may be used to derive the storage related attributes for SA_{P1}-SA_{P2}, SA_{Q1}-SA_{Q2}, and SA_{R1}-SA_{R2}. A response to the original request is generated using the derived attributes, thus reducing the management requirements of metadata in a storage system.

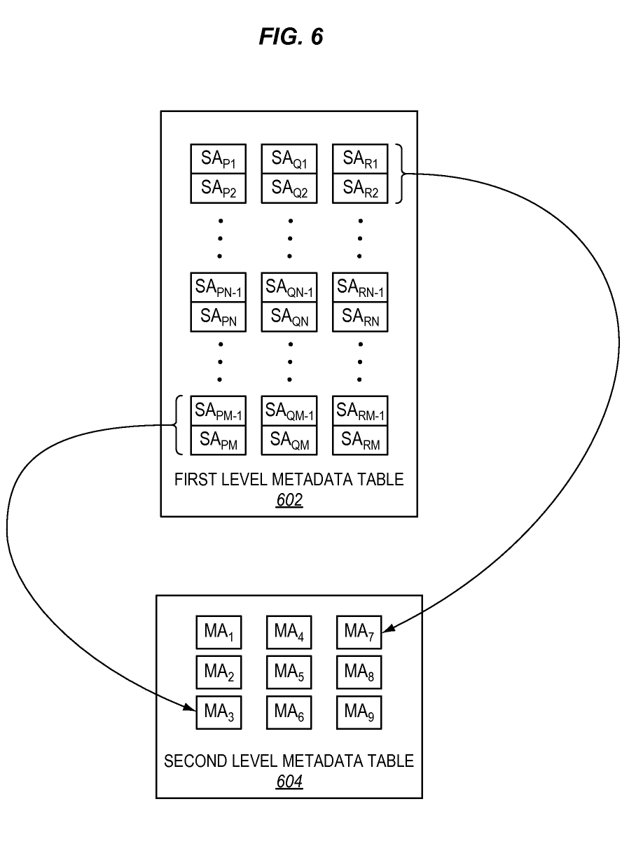

FIG. 6 depicts an exemplary first level metadata table 602 and an exemplary second level metadata table 604 in accordance with features and aspects herein. Similar to FIG. 5, FIG. 6 illustrates an alternate example of associating a second level metadata table 604 with a first level metadata table 602. In FIG. 6, metadata related attribute MA₁ corresponds with a plurality of storage related attributes SA_{P1}-SA_{P2}, MA₂ corresponds with SA_{PN-1}-SA_{PN}, and MA₃ corresponds with SA_{QM-1}-SA_{QM} in first level metadata table 602. In like manner, metadata related attribute MA₄ corresponds with a plurality of storage related attributes SA_{Q1}-SA_{Q2}, MA₅ corresponds with SA_{QN-1}-SA_{QN}, and M_{A6} corresponds with SA_{QM-1}-SA_{QM}. Similarly, metadata related attribute MA₇ corresponds with a plurality of storage related attributes SA_{R1}-SA_{R2}, MA₈ corresponds with SA_{RN-1}-SA_{RN}, and MA₉ corresponds with SAR_{M-1}-SA_{RM}. One skilled in the art will recognize that a metadata related attribute may be associated with any number of a plurality of entries in metadata table 104, each representing storage related attributes, which may span multiple storage devices, and that the configuration illustrated in FIG. 6 illustrates just one possible example of such an association.

Consider, for example, the case where first level metadata table 602 is created, but does not contain any valid storage related attribute information (i.e., the table has not been initialized). In this example, MA₁-MA₉ may include the metadata related attribute of “invalid” or “non-initialized”. Correspondingly, MA₁-MA₉ may be updated to change the “invalid” attribute to “valid” and/or “non-initialized” to “initialized” after first level metadata table 602 is populated with valid storage related attributes corresponding to portions of storage devices.

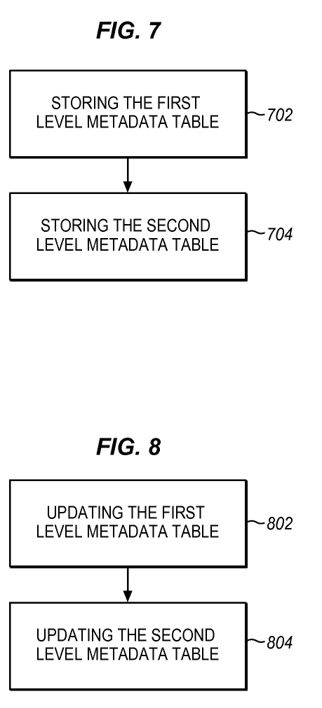

FIG. 7 is a flowchart describing an exemplary method operable on a storage controller, such as controller 102 of FIG. 1, in accordance with features and aspects herein for storing metadata in a storage system. The method of FIG. 7 may include other additional and equivalent steps not shown. One skilled in the art will recognize that such additional or equivalent steps may be omitted for brevity and clarity when describing the features and aspects of the method. Step 702 of FIG. 7 comprises storing the first level metadata table. In some cases, first level metadata table (e.g., table 104), may be stored on one or more storage devices. Additionally, a first level metadata table may be copied either in its entirety or partially from the one or more storage devices into a memory of the controller for increased performance. Step 704 comprises storing the second level metadata table on a memory of the storage controller. In some cases the second level metadata table may be stored in a volatile memory of the storage controller. In this case, the second level metadata table may be generated from the first level metadata tables stored persistently on one or more storage devices coupled with the storage controller, such as when the controller is initialized. For example, metadata related attribute MA₁ may indicate that storage attributes SA_{P1}-SA_{PM} (See FIG. 6) may be stored on storage device 108 of FIG. 4. Additionally, one skilled in the art will recognize that updating first level metadata tables and/or second level metadata tables may be performed in any order or sequence as a matter of design choice. For example, updating a second level metadata table may occur concurrently with updating a first level metadata table, or updating the second level metadata table may be performed before or after updating the first level metadata table.

When a storage system is in operation, various storage related attributes in entries of a first level metadata table associated with portions of storage devices may be updated dynamically. For example, data written to storage devices may change a storage related attribute in a corresponding entry in a first level metadata table from “unused” to “used” to reflect a change in a corresponding portion of a storage device. Because a plurality of storage related attributes in entries of the first level metadata table may be summarized by a metadata related entry in the second level metadata table, the metadata related attribute of entries in the second level metadata table may change when one or more storage related attributes in entries of the first level metadata table are changed.

FIG. 8 is a flowchart describing an exemplary method in accordance with features and aspects herein for updating metadata in a storage system. The method of FIG. 8 may include other additional and equivalent steps not shown. One skilled in the art will recognize that such additional or equivalent steps may be omitted for brevity and clarity when describing the features and aspects of the method.

Step 802 comprises updating the first level metadata table. Updating the first level metadata table may be responsive to a number of activities on one or more storage devices which modify storage related attributes in corresponding entries of a first level metadata table associated with the storage devices as previously described herein.

Step 804 comprises updating one or more entries of the second level metadata table responsive to an update to the first level metadata table. In some cases, the second level metadata table is updated continuously or after some event, such as when the storage controller is idle. For example, the second level metadata table may be updated each time the first level metadata table is updated. In other cases, the second level metadata table may be updated when the first level metadata table is written persistently to one or more storage devices. Additionally, one skilled in the art will recognize that steps 802 and 804 may be performed in any order as a matter of design choice.

It may not be desirable, however, to continuously process the first level metadata table to generate the correct metadata related attributes for the second level metadata table. For example, as portions of storage devices are written and storage related attributes are changed from “unused” to “used”, it may not be desirable to continuously process the plurality of first level metadata table entries to generate a second level metadata related attribute. Instead, it may be advantageous to maintain a counter associated with the status of the plurality of entries in the first level metadata table. For example, if a hundred first level storage related attributes were represented by a metadata related attribute in a second level metadata table, a counter may be used to indicate that ninety nine of one hundred first level metadata table entries were identical (e.g., “used”). The counter may, for example, be stored along with each metadata related attribute as additional entries in the second level metadata table. When the remaining entry in the first level metadata table is changed from “unused” to “used”, updating the counter from ninety nine to one hundred responsive to the change would indicate that the second level metadata table entry should be changed (e.g., from “partially used” to “completely used”). This type of counter activity may result in an increase in performance when updating the second level metadata table, when, for example, processing the first level metadata table to identify the change results in the storage controller performing a number of I/O operations to storage devices storing the first level metadata table.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method operable in a storage controller for managing metadata in a storage system having a plurality of storage devices, the method comprising:
associating each of a plurality of entries in a first level metadata table with a corresponding portion of the storage devices, wherein each entry in the first level metadata table identifies a storage related attribute of the corresponding portion of the storage devices;
associating each entry in a second level metadata table with a corresponding plurality of entries in the first level metadata table, wherein each entry in the second level metadata table identifies a metadata related attribute of the corresponding plurality of entries in the first level metadata table;
receiving a request for the storage related attribute in an entry in the first level metadata table;
responsive to the request:
processing the second level metadata table to identify the metadata related attribute corresponding to the entry in the first level metadata table;
deriving the storage related attribute of the entry in the first level metadata table based on the identified metadata related attribute; and
responding to the request for the storage related attribute using the derived storage related attribute.

2. The method of claim 1 wherein identifying the metadata related attribute further comprises:
identifying the metadata related attribute of the second level metadata table to be at least one of completely used, partially used, and completely unused.

3. The method of claim 1 wherein identifying the metadata related attribute further comprises:
identifying the metadata related attribute of the second level metadata table to be at least one of valid and invalid.

4. The method of claim 1 wherein identifying the metadata related attribute further comprises:
identifying the metadata related attribute of the second level metadata table to be at least one of initialized and non-initialized.

5. The method of claim 1 further comprising:
storing at least one portion of the first level metadata table on the plurality of storage devices; and
storing the second level metadata table on a memory of the storage controller.

6. The method of claim 5 further comprising:
storing the at least one portion of the first level metadata table on an identified storage device of the plurality of storage devices; and
assigning the metadata related attribute of the second level metadata table to indicate the identified storage device storing the at least one portion of the first level metadata table.

7. The method of claim 1 further comprising:
identifying a change to a storage related attribute in an entry in the first level metadata table;
identifying a metadata related attribute in the second level metadata table corresponding with the changed entry in the first level metadata table; and
updating the metadata related attribute in the second level metadata table responsive to the change in the storage related attribute.

8. A storage system comprising:
a plurality of storage devices;
a first level metadata table, wherein each entry in the first level metadata table is associated with a corresponding portion of a plurality of portions of the storage devices, and wherein each entry in the first level metadata table identifies a storage related attribute of the corresponding portion of the storage devices;
a second level metadata table, wherein each entry in the second level metadata table is associated with a corresponding plurality of entries in the first level metadata table, and wherein each entry in the second level metadata table identifies a metadata related attribute of the corresponding plurality of entries in the first level metadata table; and
a storage controller coupled with the plurality of storage devices, the first metadata table, and the second metadata table, wherein the storage controller is operable to receive a request for the storage related attribute in an entry in the first level metadata table,
wherein the storage controller, responsive to the request, is further operable to process the second level metadata table to identify the metadata related attribute corresponding to the entry in the first level metadata table,
wherein the storage controller is further operable to derive the storage related attribute of the entry in the first level metadata table based on the identified metadata related attribute, and
wherein the storage controller is further operable to respond to the request for the storage related attribute using the derived storage related attribute.

9. The storage system of claim 8 wherein the storage controller is further operable to identify the metadata related attribute of the second level metadata table to be at least one of completely used, partially used, and completely unused.

10. The storage system of claim 8 wherein the storage controller is further operable to identify the metadata related attribute of the second level metadata table to be at least one of valid and invalid.

11. The storage system of claim 8 wherein the storage controller is further operable to identify the metadata related attribute of the second level metadata table to be at least one of initialized and non-initialized.

12. The storage system of claim 8 wherein the storage controller includes a memory,
wherein the storage controller is further operable to store at least one portion of the first level metadata table on the plurality of storage devices, and
wherein the storage controller is further operable to store the second level metadata table on the memory of the storage controller.

13. The storage system of claim 12 wherein the storage controller is further operable to store the at least one portion of the first level metadata table on an identified storage device of the plurality of storage devices, and
wherein the storage controller is further operable to assign the metadata related attribute of the second level metadata table to indicate the identified storage device storing the at least one portion of the first level metadata table.

14. The storage controller of claim 8 wherein the storage controller is further operable to:
identify a change to a storage related attribute in an entry in the first level metadata table;
identify a metadata related attribute in the second level metadata table corresponding with the changed entry in the first level metadata table; and
update the metadata related attribute in the second level metadata table responsive to the change in the storage related attribute.

15. A computer readable medium tangibly embodying programmed instructions which, when executed by a computer system, are operable for performing a method of managing metadata in a storage system having a plurality of storage devices, the method comprising:
associating each of a plurality of entries in a first level metadata table with a corresponding portion of the storage devices, wherein each entry in the first level metadata table identifies a storage related attribute of the corresponding portion of the storage devices;
associating each entry in a second level metadata table with a corresponding plurality of entries in the first level metadata table, wherein each entry in the second level metadata table identifies a metadata related attribute of the corresponding plurality of entries in the first level metadata table;
receiving a request for the storage related attribute in an entry in the first level metadata table;
responsive to the request:
processing the second level metadata table to identify the metadata related attribute corresponding to the entry in the first level metadata table;
deriving the storage related attribute of the entry in the first level metadata table based on the identified metadata related attribute; and
responding to the request for the storage related attribute using the derived storage related attribute.

16. The computer readable medium of claim 15 wherein identifying the metadata related attribute further comprises:
identifying the metadata related attribute of the second level metadata table to be at least one of completely used, partially used, and completely unused.

17. The computer readable medium of claim 15 wherein identifying the metadata related attribute further comprises:
identifying the metadata related attribute of the second level metadata table to be at least one of valid and invalid.

18. The computer readable medium of claim 15 wherein identifying the metadata related attribute further comprises:
identifying the metadata related attribute of the second level metadata table to be at least one of initialized and non-initialized.

19. The computer readable medium of claim 15, the method further comprising:
storing at least one portion of the first level metadata table on an identified storage device of the plurality of storage devices; and
storing the second level metadata table on a memory of the storage controller.

20. The computer readable medium of claim 19, the method further comprising:
storing the at least one portion of the first level metadata table on an identified storage device of the plurality of storage devices; and
assigning the metadata related attribute of the second level metadata table to indicate the identified storage device storing the at least one portion of the first level metadata table.

21. The computer readable medium of claim 15, the method further comprising:
identifying a change to a storage related attribute in an entry in the first level metadata table;
identifying a metadata related attribute in the second level metadata table corresponding with the changed entry in the first level metadata table; and
updating the metadata related attribute in the second level metadata table responsive to the change in the storage related attribute.
